(19) United States
(12) Patent Application Publication
(10) Pub. No.: US 2024/0136766 A1
(43) Pub. Date: Apr. 25, 2024

(54) CONNECTORS FOR PROCESSING PACKAGES

(71) Applicants: Siva Prasad Jangili Ganga, Bengaluru (IN); Yogesh Ramakrishna Kuthkanahalli, Bengaluru (IN); Lianchang Du, Kunshan (CN); Chuansheng Liu, Shanghai (CN); Ligang Wang, Shanghai (CN); Narayanasamy Soundararajan, Telangana (IN); Jeffory L. Smalley, Olympia, WA (US)

(72) Inventors: Siva Prasad Jangili Ganga, Bengaluru (IN); Yogesh Ramakrishna Kuthkanahalli, Bengaluru (IN); Lianchang Du, Kunshan (CN); Chuansheng Liu, Shanghai (CN); Ligang Wang, Shanghai (CN); Narayanasamy Soundararajan, Telangana (IN); Jeffory L. Smalley, Olympia, WA (US)

(21) Appl. No.: 18/400,282

(22) Filed: Dec. 29, 2023

(51) Int. Cl. H01R 13/631; H01R 12/75; H01R 13/502

(52) U.S. Cl. CPC H01R 13/631; H01R 12/75; H01R 13/502

(57) ABSTRACT

Connectors for processing packages are disclosed herein. An example male connector includes a plurality of wires. The example male connector further includes a socket pin. The example male connector further includes a paddle board connected to the socket pin. The example male connector further includes an overmolded cable housing the plurality of wires, the overmolded cable coupled to the paddle board, one of the plurality of wires coupled to the socket pin via the paddle board. The example male connector further includes a molded region to encompass the plurality of wires within a flat portion, the overmolded cable housing and the molded region to increase a height of the wires from the paddle board from a first height to a second height.

### FIELD OF THE DISCLOSURE

This disclosure relates generally to socket connectors and, more particularly, to connectors for processing packages.

### BACKGROUND

The demand for greater computing power and faster computing times continues to grow. This has led to structures for transferring high speed signals on computer hardware components to transfer signals between components more quickly.

### BRIEF DESCRIPTION OF THE DRAWINGS

FIG. 1A is a perspective view of an example assembly for a processing package constructed in accordance with teachings of this disclosure.

FIG. 1B is a perspective view of a portion of the example assembly of FIG. 1A.

FIG. 2 is an exploded view of the example assembly of FIG. 1.

FIG. 3 is a top view of the example processing package of FIG. 2.

FIG. 4A is a perspective view of an example male connector for a cable of FIG. 2.

FIG. 4B is a side perspective view of the example male connector of FIG. 4A.

FIG. 4C is a side view of the example male connector of FIGS. 4A and/or 4B.

FIG. 4D illustrate another portion of the example male connector of FIGS. 4A and/or 4B.

FIG. 5 is a perspective view of a portion of an example loading mechanism of FIG. 2.

FIGS. 6A-6G are cross-sectional views or perspective views of the assembly of FIGS. 1A and/or 1B in accordance with different positions of the male connector of FIGS. 4A-4D as the male connector is inserted into the female connector.

FIGS. 7A-7B are cross-sectional views or perspective views of the assembly of FIGS. 1A and/or 1B in accordance with different positions of the male connector of FIGS. 4A-4D as the male connector is ejected from the female connector.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used in this patent, stating that any part (e.g., a layer, film, area, region, or second housing) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” or “engaged” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

As the computing industry evolves, the demand for higher input/output (IO) speeds and throughput continues to increase. A package (e.g., also referred to as a processing package or a silicon package) may include computer hardware components, such as processing circuitry (e.g., central processing units (CPUs), graphical processing units (GPUs), etc.), memory, motherboards, etc. The package may utilize one or more components to carry or transmit signals (e.g., high speed, 112 Gigabit (G) Ethernet signals) from the package to a main board (e.g., circuit board, printed circuit board (PCB), integrated circuit (IC), etc.). However, having a socket on the board to interface with a cable to obtain signals, can result in signal loss. For example, signal loss can occur from transmitting the signal from a package to a socket and then from the socket to the board. Examples disclosed herein include a shielded cable technique to connect to package signals on package footprint using a socket to reduce the signal loss.

There are various difficulties with the use of a shielded cable solution. The first difficulty is that processing packages typically include a heat sink attached to the processing package. The location of the heat sink can make it difficult to attach and detach a cable without removing the heat sink. For example, there may be limited space to place a female connector for interfacing the processing package given size and/or space needed for the heat sink. For example, the amount of space to connect a cable may be less than 7 mm Removing a heat sink from a processing package to access a cable can be difficult and/or cause damage to the processing package and/or the main circuit board (e.g., due to a thermal trip and/or thermal failure on the processing package). Additionally, there may be other structures or components on the board (e.g., voltage regulators, voltage regulating inductors, capacitors, inductors, etc.) that may impede the path of a cable.

Examples disclosed herein provide structures for a male connector and a female connector to facilitate transmission of signals to/from a processing package via a shielded cable. In examples disclosed herein, the male connector couples to the end of the cable and is structured to be connected to or disconnected from the female connector in a socket of the processing package. The disclosed male connector is structured to protect the socket pins of the male connector and connect to the female connector without removal of the heat sink and while avoiding impeding structures on the board.

To connect to a female connector on a processing board, the example male connector disclosed herein is structured with an overmolded cable that positions the wires in parallel. The parallel structure flattens the overall structure of the cable. The flattened structure then can be molded to, for example, a sigmoid shape, an angled shape, a step shape, etc. to allow the male connector to interface with the female connector without interfering with any impeding structure(s) on the board. The male connector further includes a paddle board that connects the parallel wires (e.g., corresponding to differential signals and/or a differential pair cable) to a paddle board and socket pins on the male connect assembly. In this manner, the user can easily maneuver the male connector to engage the female connector. The male connector further includes mechanisms for holding the male connector in place and facilitating the ejection of the male connector without removing the heat sink and/or damaging the socket pins.

The female connector disclosed herein includes surface-mount technology (SMT) pins to align and hold the male connector into position (e.g., an intended position) in response to being connected. Additionally, to hold the male connector in place, the female connector includes a mechanism to engage a clip of the male connector after the male connector is inserted into the female connector. The female connector disclosed herein further includes spring mechanism(s) to press the socket pins of the male connector into contact with landing pad(s) and/or interface(s) of the female connector to establish a connection. One of the springs may be coupled to a loading screw (or other type of fastener) that is accessible via a cavity within the heat sink. In this manner, after the male connector is placed into the female connector, a user can tighten the loading screw to cause the spring to push the socket pins of the male connector into contact with the landing pad(s) and/or interface(s) of the female connector. Additionally, the spring mechanism(s) of the female connector facilitate the ejection of male connector without removing the heat sink and/or damaging the socket pins.

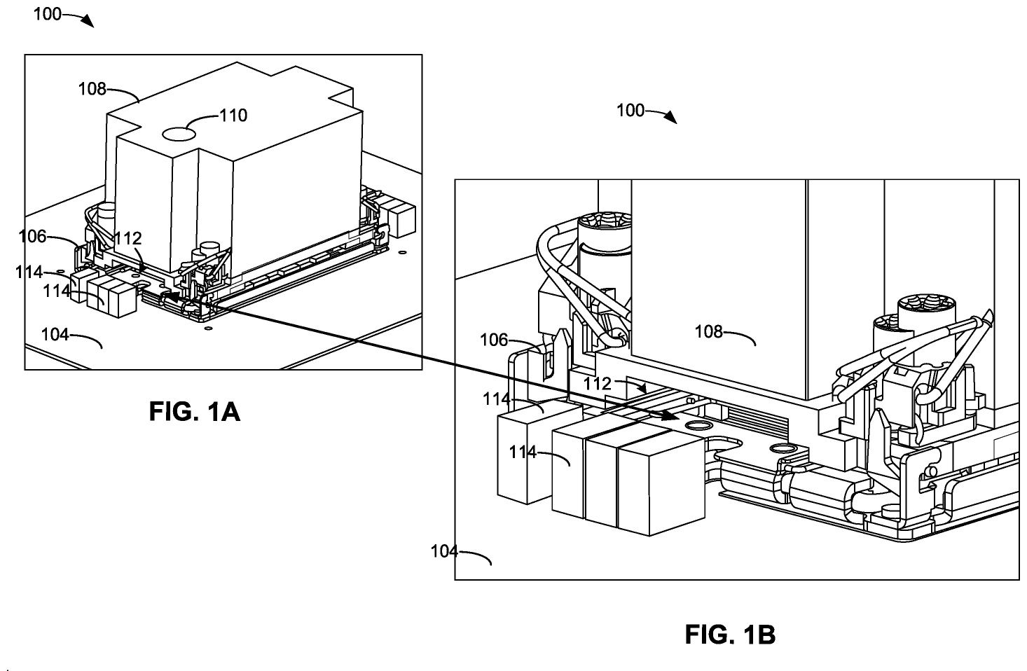

FIGS. 1A and 1B illustrate two views of an example assembly 100 for a processing package on an example circuit board 104. The example assembly 100 includes an example package assembly 106, an example heat sink 108, an example cavity 110, an example female connector 112, an example impeding structures 114. In the example of FIGS. 1A and/or 1B, the impeding structures 114 are inductors. However, the impeding structures 114 could be voltage regulators, voltage regulating inductors, capacitors, and/or any other component that may impede the path of a cable and/or male connector.

The circuit board 104 of FIGS. 1A and/or 1B is coupled to several components to operatively couple two or more of those components. For example the circuit board 104 connects to (e.g., interfaces with) a processing package in the package assembly 106, the impending structures 114 and/or any other components (e.g., electrical components, memory, registers, hardware, etc.) attached, or otherwise connected, to the circuit board 104. The circuit board 104 may be an chip, an IC, a PCB, a breadboard, and/or any other device that connects electrical components.

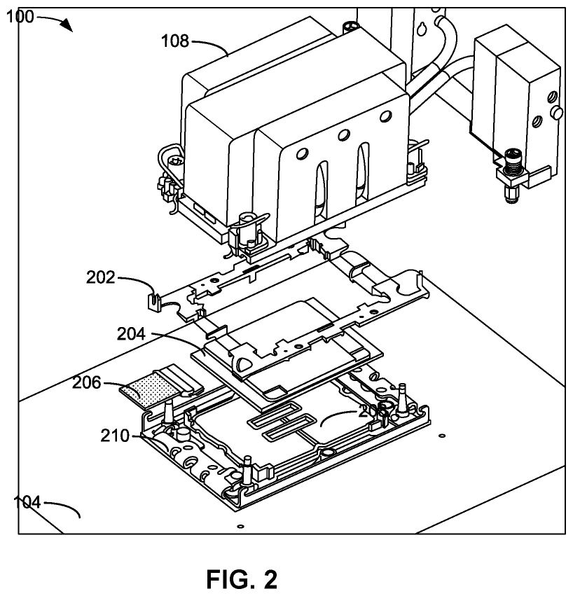

The package assembly 106 of FIGS. 1A and/or 1B includes components that attach to and/or protect a processing package. For example, the package assembly 106 may include a loading mechanism (FIG. 2) to couple the processing package to the circuit board 104 and/or a carrier (FIG. 2) to couple the processing package to the heat sink 108. The package assembly 106 includes an opening defined in the female connector 112 to receive a male connector. The package assembly 106 is coupled to the heat sink 108 and the circuit board 104. The package assembly 106 is further disclosed below in conjunction with FIG. 2.

The heat sink 108 of FIGS. 1A and/or 1B is a passive heat exchange that transfers heat generated by the processing package to another medium to dissipate heat away from the processing package and/or circuit board 104. Thus, the heat sink 108 protects the processing package, circuit board 104 and/or other components from damage that could be caused by excessive heat produced by the processing circuitry. Accordingly, a size, material, and/or other design features of the heat sink can be selected so that the temperature near the processing package remains below a threshold. The heat sink 108 is coupled to the package assembly 106.

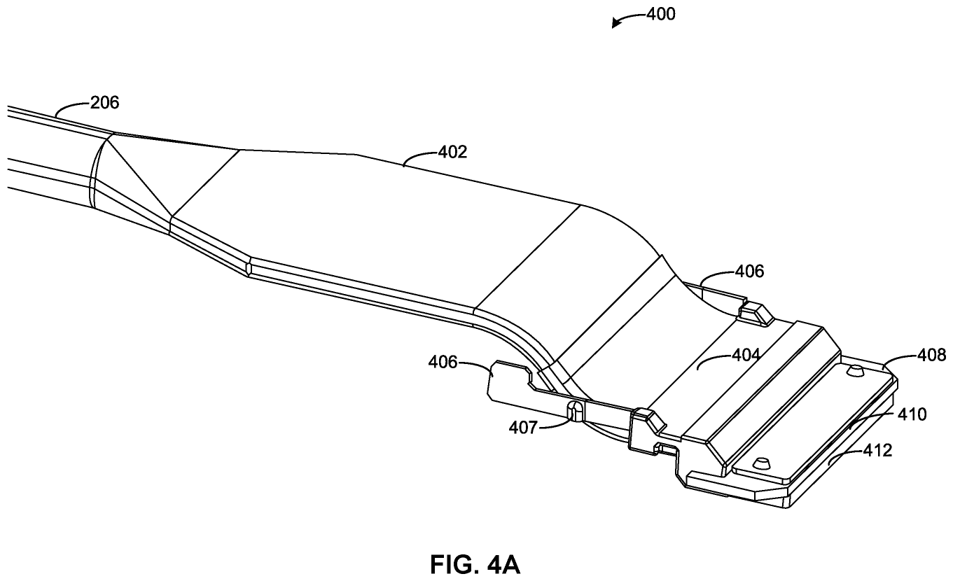

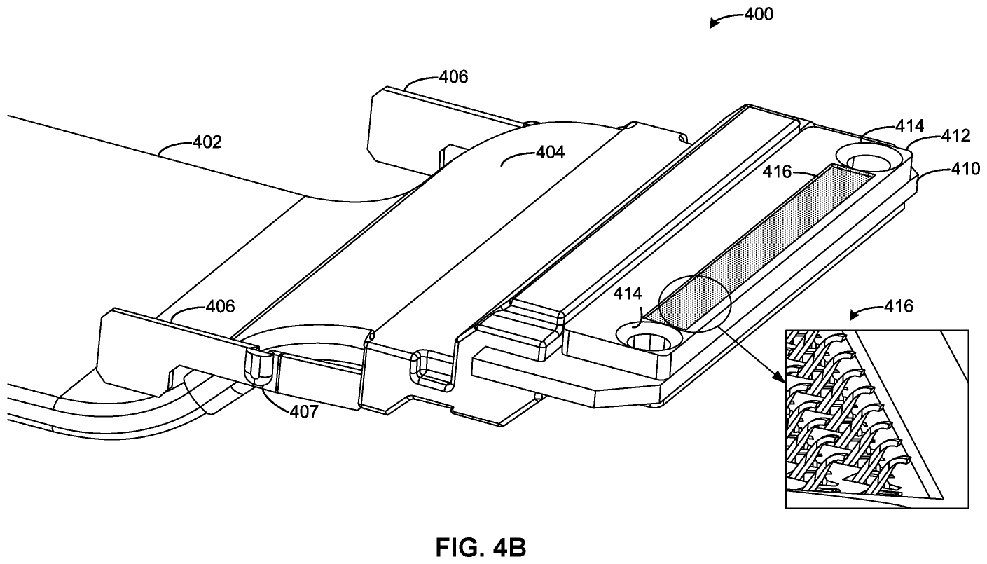

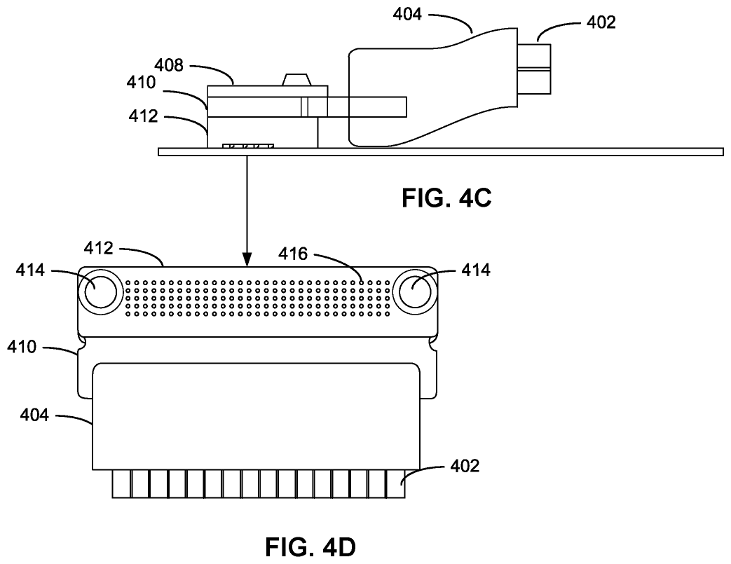

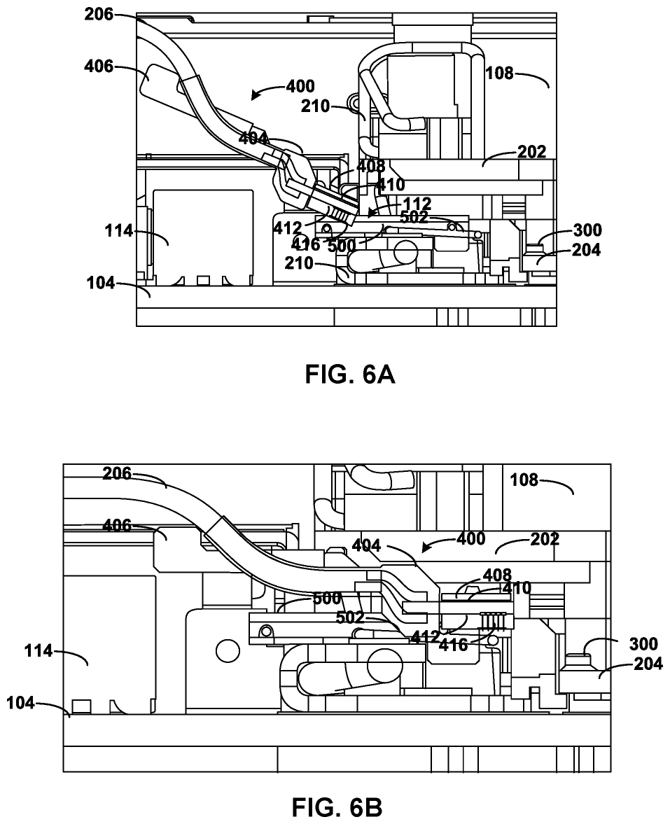

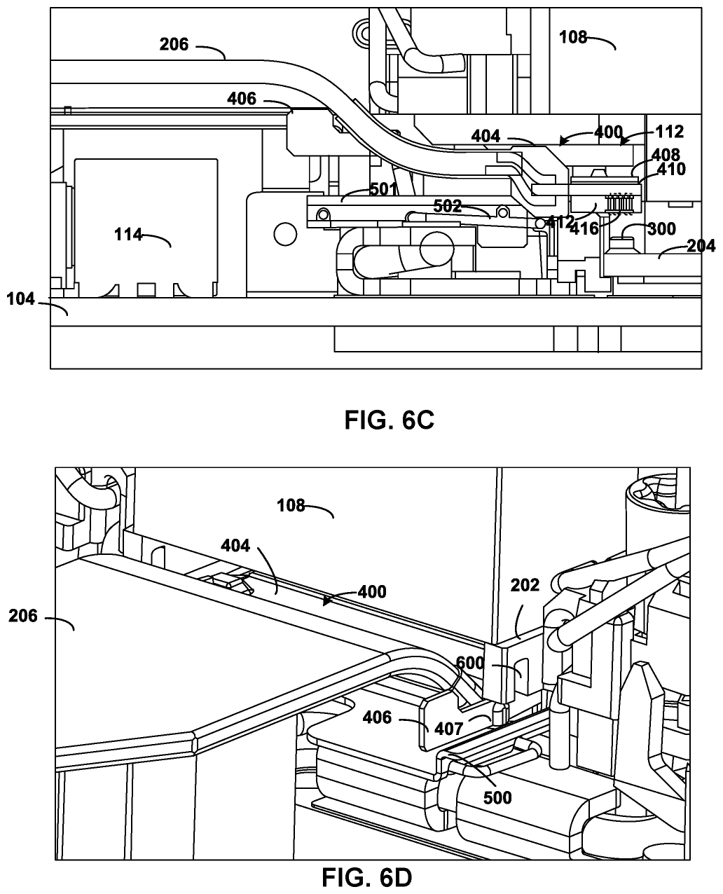

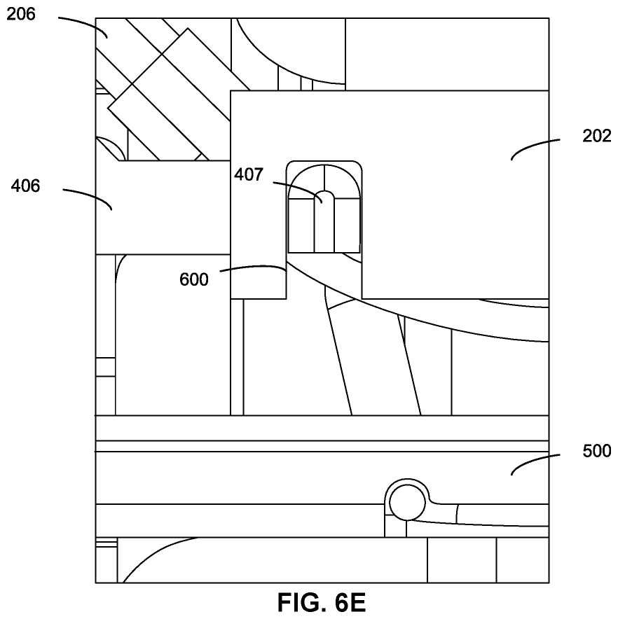

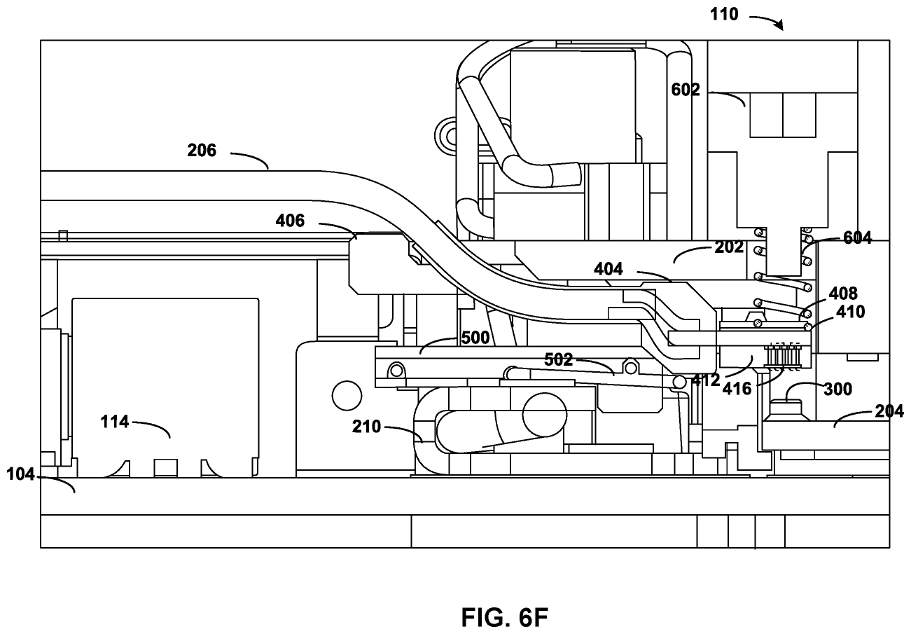

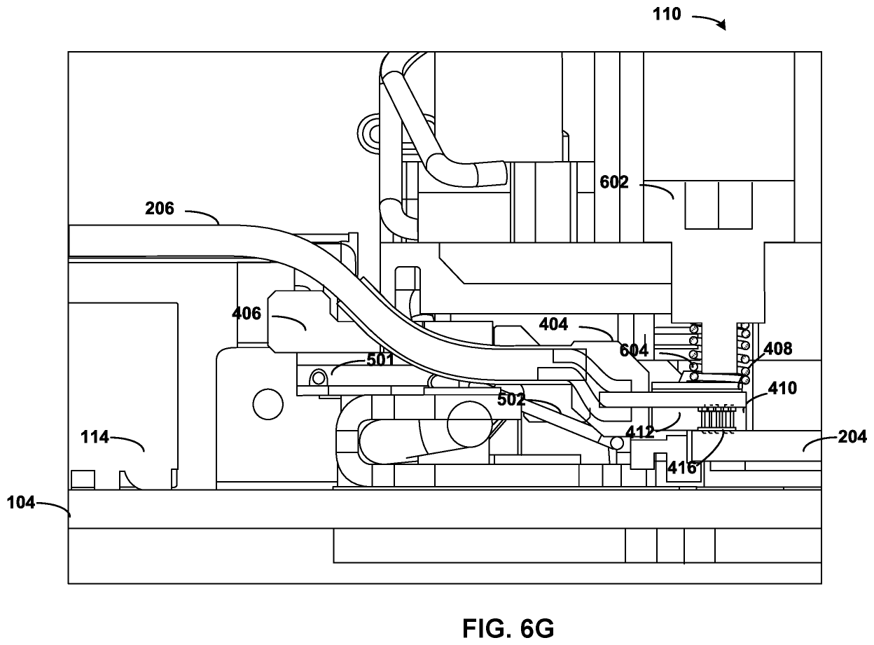

The heat sink 108 includes the cavity 110 of FIGS. 1A and/or 1B. The cavity 110 is an opening and/or empty space where a loading screw can be placed. As disclosed below in conjunction with FIG. 6F, the loading screw can be engaged (e.g., pressed, turned, etc.) to cause a spring to press and/or secure socket pins of a male connector (FIGS. 4A-4D) into contact with landing pad(s) of a processing package after the male connector is inserted. Additionally, the loading screw can be engaged to cause the spring to release the engagement of the socket pints of the male connector from the female connector when ejecting the male connector.

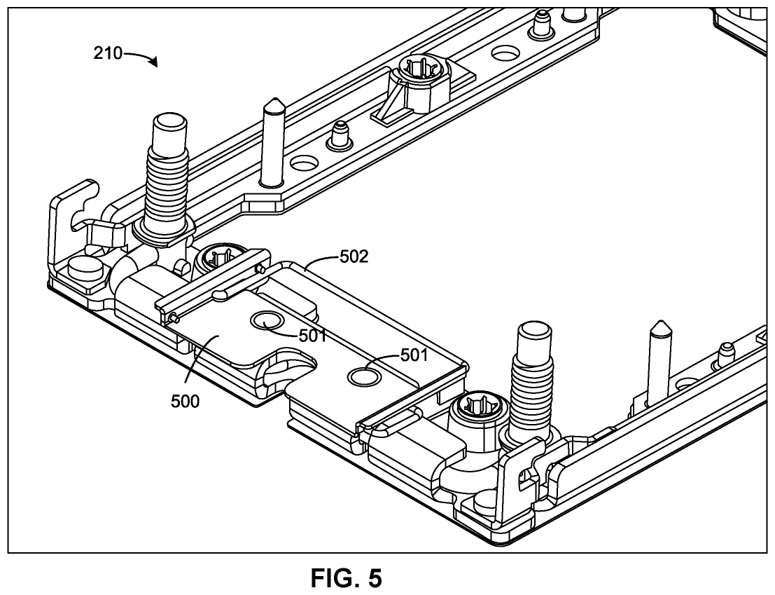

The female connector 112 of FIGS. 1A and/or 1B (also referred to as a socket, a slot, a cable slot, a cavity, etc.) includes components for securing a male connector in a connected position so that the connector pins of the male connector align with and are securely in contact with the landing pad(s) of a processing package. For example, the female connector 112 may include guide rail brackets that complement or correspond to the shape of the male connector so that the male connector is properly aligned when inserted into the female connector 112. Additionally, as further disclosed below in conjunction with FIGS. 5, 6F, and/or 6G, the female connector 112 includes one or more springs to aid in the connection and/or ejection of the male connector to/from the processing package. In the example of FIGS. 1A and/or 1B, the opening for the female connector 112 is about 7 millimeters (mm) high (e.g., from the base of the female connector 112 to the package assembly 106). However, the height may be any height (e.g., based on the requirements of the processing package and/or heat sink 108).

FIG. 2 is an exploded view of the assembly 100 of FIGS. 1A and/or 1B. FIG. 2 includes the circuit board 104 and the heat sink 108 of FIGS. 1A and/or 1B. FIG. 2 further illustrates an example carrier 202, example processing package 204, an example cable 206, an example processing circuitry socket 208, and an example loading mechanism 210.

The carrier 202, processing package 204, processing circuitry socket 208, and loading mechanism 210 of FIG. 2 define the package assembly 106 of FIGS. 1A and/or 1B. In the example orientation shown in FIG. 2, the carrier 202 is located below the heat sink 108 and above the processing package 204. The carrier 202 couples the heat sink 108 to the rest of the assembly 100. Additionally, the carrier 202 defines the upper portion of the female connector 112.

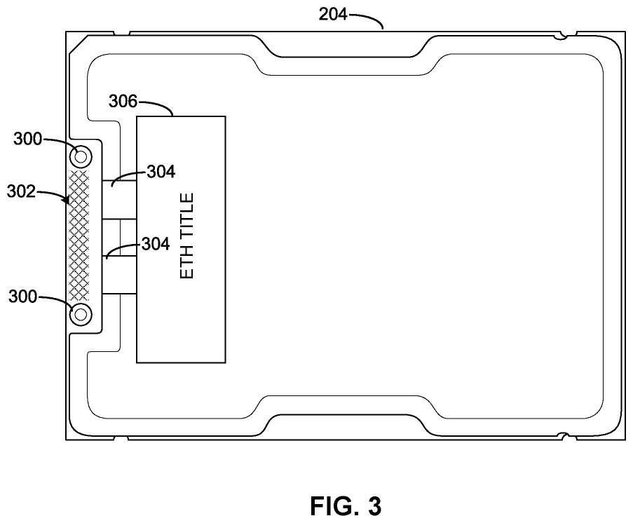

The processing package 204 of FIG. 2 includes processing circuitry to execute instructions and/or tasks. As further disclosed below, the cable 206 is structured to connect to and/or eject from the processing package 204 without removal of the heat sink 108. Thus, the processing package 204 includes one or more landing pad(s) and/or interface(s) to connect with the one or more socket pins of the cable 206 to interface with another device, as further disclosed below in conjunction with FIG. 3. The processing package 204 interfaces (e.g., obtains and/or transmits data) to other components on the circuit board 104 via the processing circuitry socket 208. For example, the processing package 204 is connected to the socket 208, which is connected to one or more traces, wires, connections, and/or interfaces of the circuit board 104.

The cable 206 of FIG. 2 includes one or more wires, interfaces, and/or connections to transfer data to and/or from the processing package 204. For example, the cable 206 may be an Ethernet cable (e.g., a high speed Ethernet cable), a universal serial bus (USB) cable, and/or any other cable. In some examples, the cable 206 is structured to carry one or more signals (e.g., differential signals, non-differential signals, etc.) via one or more connections. The cable 206 includes a male connector to connect to the female connector 112 of the assembly 100. The male connector is further discussed below in conjunction with FIGS. 4A-4C.

The loading mechanism 210 of FIG. 2 couples the assembly 100 to the circuit board 104. The loading mechanism 210 may be connected to the carrier 202 and/or the heat sink 108 to facilitate securing of the component(s) of the assembly 100 in intended position(s). In the example orientation shown in FIG. 2, the loading mechanism 210 forms the bottom portion of the female connector 112 and the carrier 202 forms the top portion of the female connector 112. As further disclosed below in conjunction with FIG. 5, the loading mechanism 210 includes the guiderail bracket and/or spring of the female connector 112 to aid in the insertion and ejection of the cable 206.

FIG. 3 is a top view of the example processing package 204 of FIG. 2. The processing package 204 includes example mounting pins 300 (e.g., SMT pins), example landing pads 302, example routing 304, and an example tile (e.g., an Ethernet tile) 306.

The mounting pins 300 of FIG. 3 are structures that engage with mounting openings and/or sockets (e.g., SMT sockets) of the male connector (FIGS. 4A-4B) of the cable 206 to facilitate alignment of the male connector 400 and/or to help secure the male connector relative to the female connector 112. In some examples the mounting pins 300 are soldered to the processing package 204. In some examples, the mounting pins 300 are about 2 mm in diameter. However, the diameter could be any size.

The example landing pads 302 of FIG. 3 connect to the socket pins of the male connector of the cable 206 when the male connector is connected within the female connector 112. In this manner, the connections of the cable 206 can be routed to corresponding landing pads for communication with the processing circuitry of the processing package 204 (e.g., via the tile 306). Thus, signals can be routed to/from the tile 306 via the landing pads 302.

The example routing 304 of FIG. 3 provides connections from the landing pads 302 to the tile 306. For example, the routing 304 may be etches, wires, connections, interface(s), etc. that connect the landing pads 302 to the tile 306 (e.g., each landing pad connected to the tile 306 via an etch or route).

The tile 306 of FIG. 3 operates as an interface between an external device and the processing circuitry of the processing package 204. For example, the tile 306 can obtain and/or transmit data to another device using the cable 206 via the routing 304 and the landing pads 302.

FIG. 4A illustrates an example male connector 400 of the cable 206 (also referred to as a cable housing, a housing, etc.) of FIG. 2. The male connector 400 includes an example molded region 402, an example overmolded cable region 404, example clips 406 including example protrusions 407, an example plate 408, an example paddle board 410, and an example socket connector 412.

The molded region 402 of FIG. 4A is a housing that converts the round cable 206 that may include multiple different wires into a flat connection. For example, the molded region 402 may align the multiple wires laid side by side in parallel to generate a flat portion of the cable 206. The flat portion of the molded region 402 is in parallel with the paddle board 410. In this example, the molded region 402 further includes a curved portion that feeds into (e.g., is attached to) a curved portion of the overmolded cable portion 404. For example, in FIG. 4A, the flat portion of the molded region 402 is fed into the overmolded cable portion 404 to generate a sigmoid shape (e.g., which moves the housed/enclosed wires from a first height to a second height). The flat portion of the molded region 402 is flat in comparison to the rounded portion of the cable 206. For example, the wire within the cable 206 may be bundled and encased in the round portion of the cable 206. The wires are organized in parallel to create the flattened region. The flattened region may also be referred to as a ribboned region or a planar region. In some examples, a flattened region is a region with points on the surface that are coplanar (e.g., within manufacturing tolerances). Although the combination of the molded region 402 and the overmolded cable region 404 correspond to a sigmoid shape, the two regions could be structured to make a sloped or angled shape, a step shape, and/or any other shape to reduce the height (e.g., with respect to the paddle board 410) of the position (e.g., corresponding to the position of the cable 206) to a second position (e.g., corresponding to the position of the paddle board 410). In some examples, the overmolded cable portion 404 may extend further into the molded region 402 to further define the sigmoid shape.

The example overmolded cable portion 404 of FIG. 4A (also referred to as a housing or retainer) of the male connector 400 is a housing made of a more rigid material than the rest of the cable 206 to maintain the shape of the male connector 400. The overmolded cable portion 404 encloses and/or houses the wires within the cable 206. The overmolded cable portion 404 is structured to position the wires from the molded region 402 in the angled position to a flat position with respect to (e.g., in parallel with) the paddle board 410. Additionally, the overmolded cable portion 404 holds and/or is otherwise coupled to the paddle board 410. The overmolded cable portion 404 is coupled to the clips 406.

The clips 406 of FIG. 4A provide a snapping mechanism to eject the cable 206 from the female connector 112. The clips 406 can be pushed in toward the overmolded cable portion 404 and, when released, will return to an initial position. Although the illustrated example include two clips 406, there may be one or more clips connected to the overmolded cable portion 404. Each of the clips 406 include the protrusion 407. However, in some examples, only one of the clips may include the protrusion 407. The protrusion will, when the male connector 400 is inserted into the female connector 112 engage with a slot or opening to hold the male connector 400 at a particular location. To release the male connector 400 from the female connector 112, the clips 406 can be pressed toward the overmolded cable portions 404 to cause the protrusion(s) 407 to disengage the slot or opening of the female connector 112 to allow the male connector 400 to be pulled out from the female connector 112. The engagement and disengagement of the clip 406 is further discussed below in conjunction with FIG. 6D-6E.

The plate 408 of FIG. 4A is to come into contact with a spring mechanism of the female connector 212. The plate 408 facilitates the engaging of the male connector 400 to the landing pads 302 of the processing package 204 without causing damage to the paddle board 410. The paddle board 410 of FIG. 4A provides a connection between the wires of the cable 206 and socket pins of the socket connector 412. The paddle board 410 may be a silicon substrate. The paddle board 410 may include one or more metal contact pads and one or more traces that electrically connect the wires in the cable 206 to socket pins of the socket connector 412. The socket connector 412 houses and protects the socket pins that engage the landing pads 302 of the processing package 204 when the male connector 400 is fully connected to the female connector 112.

FIG. 4B shows a side of the male connector 400 opposite the side of the male connector 400 shown in FIG. 4A. FIG. 4B includes the example molded region 402, the example overmolded cable region 404, the example clips 406 including the example protrusions 407, the example paddle board 410, and the example socket connector 412 of FIG. 4A. FIG. 4B further shows an example mounting opening 414 and example socket pins 416.

The mounting openings 414 of FIG. 4B may be SMT sockets and/or openings that engage the mounting pins 300 of FIG. 3 when the male connector 400 is pressed toward the processing package 204 by a spring of the female connector 112. The mounting pins 300 are structured to engage the mounting openings 414 to hold the male connector 400 into place so that the socket pins 416 remain in contact with the appropriate landing pads 302 of FIG. 3 after the male connector 400 has been pressed into contact with the landing pads 302. In some examples, the mounting pins 300 are friction fit in the openings 414.

The socket pins 416 of FIG. 4B connect to a corresponding wire of the cable 206 via the paddle board 410. In the example of FIG. 4B, the socket pins 416 is a land grid array (LGA) based pin contact connector. However, the socket pins 416 may be any type of surface-mount pin structure. The socket pins 416 are constructed of conductive material, such as metal (e.g., copper, gold, silver, aluminum, etc.). In this example, the socket connector 412 includes N rows and M columns of socket pins. However, the socket connector 412 can include any number of socket pins 416 in any pattern. In some examples, the socket connector 412 may include only one socket pin. In other examples, the socket connector 412 can include tens, hundreds, or even thousands of socket pins. The socket pins 416 are arranged in a tight or dense configuration to reduce (e.g., minimize) space consumption.

FIG. 4C illustrates a side view) of the male connector 400 of FIGS. 4A and 4B. FIG. 4D illustrates a portion of the male connector 400 of FIGS. 4A and 4B including the example the example socket connector 412. FIGS. 4C and/or 4D includes the example molded region 402, the example overmolded cable region 404, the example clips 406 including the example protrusions 407, the example plate 408, the example paddle board 410, the example socket connector 412, the example mounting opening 414, and the example socket pins 416 of FIGS. 4A and/or 4B. In the example of FIGS. 4C and/or 4D, the molded region 402 includes differential pair of cable connectors to the paddle board 410. However, the molded region 402 can include any number of cable(s) (differential or non-differential).

FIG. 5 illustrates a portion of the loading mechanism 210 of FIG. 2. The loading mechanism 210 includes an example guide rail bracket 500, example rivets 501 and an example spring 502. The guide rail bracket 500, the rivets 501, and/or the spring 502 define a portion of the female connector 112.

The example guide rail bracket 500 of FIG. 5 is shaped to allow the male connector 400 to insert into the female connector 112. Accordingly, the guide rail bracket 500 includes walls or other protrusions or extensions to help secure the male connector 400 when inserted. The guide rail bracket 500 is coupled to the loading mechanism 210 using the example rivets 501. However, the loading mechanism 210 could be coupled to the loading mechanism 210 using any coupling technique. The guide rail bracket 500 also is coupled to and/or houses the spring 502.

The spring 502 of FIG. 5 exerts a force (e.g., toward the heat sink 108) when pressed (e.g., toward the circuit board 104). In the example of FIG. 5, the spring 502 is shown in an initial position. In the initial position, the spring 502 extends in parallel from the guide rail bracket 500. When a force is applied to the spring 502 to move the spring 502 to a compressed position, the spring 502 exerts force in a direction corresponding to the initial position of the spring 502 based on a spring constant. In the compressed position, the spring 502 is disposed at an angle relative to the guide rail bracket 500. As further disclosed below in conjunction with FIGS. 6A-6G, when the male connector 400 is inserted into the female connector 112, a user can interface with (e.g., tighten) a fastener such as a screw to cause the male connector 400 to lower until the male connector 400 is in contact with the landing pads 302 of the processing package 204. Because the force of the screw is stronger than the force of the spring 502, the spring will move to the compressed position in response to the movement of the male connector 400 and exert a force on the male connector 400 until the screw is released. When the screw is released, the spring 502 pushes the male connector 400 toward the heat sink 108 until the spring 502 reaches (i.e., returns to) the initial position. In this manner, the user can remove the male connector 400 with less risk of damage by pulling the male connector 400 out and away from the guide rail bracket 500.

FIGS. 6A-6G illustrate different positions of the male connector 400 of FIG. 4 while inserting the male connector 400 into the female connector 112. FIGS. 6A-6G include the circuit board 104, the heat sink 108, the female connector 112, and the impeding structure 114 of FIGS. 1A and/or 1B. FIGS. 6A-6G further include the carrier 202, the processing package 204, the cable 206, and the loading mechanism 210 of FIG. 2. FIGS. 6A-6G further include the mounting pin 300 of FIG. 3. FIGS. 6A-6G further include the male connector 400, the example overmolded cable region 404, the example clips 406 including the example protrusions 407, the example plate 408, the example paddle board 410, the example socket connector 412, and the socket pins 416 of FIGS. 4A and/or 4B. FIGS. 6A-6G further include the example guide rail bracket 500 and the example spring 502 of FIG. 5. FIGS. 6A-6G further include an example protrusion mating component 600, an example fastener 602, and an example spring 604.

FIG. 6A illustrates a first position of the male connector 400 as the male connector 400 is being inserted into the female connector 112 formed by the carrier 202 and the loading mechanism 210. Because of the shape of male connector 400 defined by the overmolded cable region 404 and the plate 408, the male connector 400 can be inserted into the female connector 112 while avoiding the impeding structure 114 connected to the circuit board 104.

In FIG. 6B, the male connector 400 reaches a second position as the male connector 400 moves toward the processing package 204 within the guide rail bracket 500. In the second position, the paddle board 410 of the male connector 400 is parallel with the processing package 204. The example sigmoid shape of the cable 206 allows the male connector 400 to enter into the female connector 112 at a position below the top of the impeding structure 114 without touching the impeding structure 114. Additionally, the male connector 400 is above the spring 502. However, because the spring 502 is in the initial position, the spring 502 does not yet apply a force to the male connector 400.

In FIG. 6C, the male connector 400 reaches a third, fully inserted, position into the female connector 112. In the third position, socket pins 416 of the male connector 400 is directly above the landing pads 302 of the processing package 204 when in the orientation shown in FIG. 6C. Additionally, as further disclosed below in conjunction with FIGS. 6D and 6E, in the third fully, inserted position, the protrusion 407 of the clip 406 engages with a protrusion mating component 600 of the carrier 202 to hold the male connector 400 into the third position (e.g., so that the male connector 400 does not slide back out from the female connector 112). After the male connector 400 is secure in the third, fully inserted position, a user can interface (e.g., press, twist, screw, etc.) with a fastener (e.g., a screw) to cause a spring to press the male connector 400 down toward the circuit board 104 until the socket pins 416 engage the landing pads 302 of the processing package 204.

FIGS. 6D and 6E illustrate two view of the male connector 400 in the third, fully inserted, position. FIGS. 6D and 6E illustrate the protrusion mating component 600 (e.g., an opening, a slot, etc.) which includes an opening for the protrusion 407 of the clip 406 to engage with. For example, in the third, fully inserted position, the protrusion 407 is aligned with the opening of the protrusion mating component 600 to engage with the protrusion mating component 600. In this manner, the male connector 400 will not be removed (e.g., accidently) or fall out of the female connection 112 unless a user presses the clip 406 toward the cable 206 to cause the protrusion to exit the protrusion mating component 600, thereby allowing the male connector 400 space to slide out of the female connector 112. In this example, a length of the opening of the protrusion mating component 600 is defined so that the protrusion 407 will remain engaged with the protrusion mating component 600 when the male connector 400 is pressed down by a spring to connect the male connector 400 with the landing pads 302 of the processing package 204.

FIG. 6F illustrates the example fastener 602 (e.g., a screw or other means for securing) in a first position. In the first position, the fastener 602 does not press the spring 604 into the plate 408 of the male connector 400. Thus, the male connector 400 remains above and disengaged from the processing package 204. To engage the socket pins 416 of the male connector 400 with the landing pads 302 of the processing package 204, a user can press, twist, screw, and/or otherwise engage the fastener 602 to cause the fastener 602 to move toward the processing package 204, thereby causing the spring 604 to press the male connector 400 towards the processing package 204. As disclosed above in conjunction with FIGS. 1A and/or 1B, the heat sink 108 includes the cavity 110 to allow a user to access the example fastener 602.

FIG. 6G illustrates the fastener 602 (e.g., a screw) into a second, engaged position. In the second position, the fastener 602 presses the spring 604 into the plate 408 of the male connector 400 to cause the male connector 400 to move into contact and/or engagement with the processing package 204. As disclosed above, the socket connector 412 includes an opening to engage the mounting pins 300 to cause the socket pins 416 of the male connector 400 to come into contact with respective landing pads 302 of the processing package 204. Additionally, as shown in FIG. 6G, pressing the male connector 400 down and into contact with the processing package 204 cause the spring 502 of the female connector 112 to move into a second position. The spring 502 in the second position applies a force on the male connector 400 (e.g., in a direction toward the heat sink 108). However, the force applied by the spring 604 toward the circuit board 104 is stronger than the force applied by the spring 502. Accordingly, the male connector 400 remains engaged with the processing package 204 until a user disengages the fastener 602.

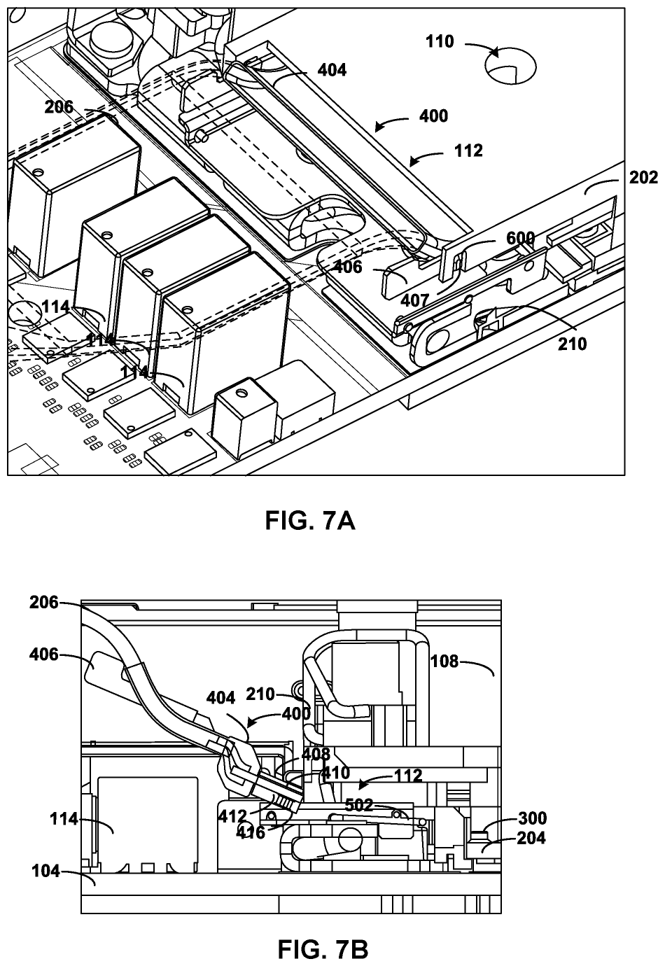

FIGS. 7A-7B illustrate different positions of the male connector 400 of FIG. 4 while ejecting into the female connector 112. FIGS. 7A-7B include the circuit board 104, the heat sink 108, the female connector 112, and the impeding structure 114 of FIGS. 1A and/or 1B. FIGS. 7A-7B further include the carrier 202, the processing package 204, the cable 206, and the loading mechanism 210 of FIG. 2. FIGS. 7A-7B further include the mounting pin 300 of FIG. 3. FIGS. 7A-7B further include the male connector 400, the example overmolded cable region 404, the example clips 406 including the example protrusions 407, the example plate 408, the example paddle board 410, the example socket connector 412, and the socket pins 416 of FIGS. 4A and/or 4B. FIGS. 7A-7B further include the example guide rail bracket 500 and the example spring 502 of FIG. 5.

To eject the male connector 400 from the female connector 112, the fastener 602 is disengaged. For example, a user can press-to-release, unscrew, etc. the fastener 602 via the cavity 110 to cause the fastener 602 to move away from processing package 204. As the fastener 602 moves away from the processing package 204 the spring 604 extends (e.g., toward the circuit board 104). Because, in the fully connected position corresponding to FIG. 6G, the male connector 400 presses on the spring 502, the spring 502 exerts an opposing force (e.g., in a direction toward the heat sink 108) on the male connector 400. Accordingly, as the fastener 602 moves and the spring 502 is released, the spring 502 pushes the male connector toward the heat sink (e.g., corresponding to the position of FIG. 6F).

After the fastener 602 disengages with the male connector 400, to release the male connector 400 from the female connector 112, a user can press or squeeze the clip 406 (e.g., toward the edges of the overmolded cable region 404) to release the protrusion 407 of the clip 406 from the protrusion mating component 600 of the carrier 202. While the protrusion(s) 407 is/are released, a user can pull the male connector 400 away/out from the female connector 112, as shown in FIG. 7B. Thus, the cable 206 can be disconnected from the landing pads 302 of the processing package 204 and removed from the female connector 112 without having to remove the heat sink 108.

While the terms top, bottom, over, under, above, and below are used herein to describe the relationship between certain components, it is understood that these terms are relative to the Earth or ground reference in a specific orientation. However, the example components disclosed herein can be disposed in any orientation. As such, in a first orientation, a first part may be described as being under a second part relative to the Earth reference, but in a second orientation, the first part may be over the second part relative to the Earth reference. Thus, these terms do not limit the components to a specific orientation. Also, while in some examples two or more components are described as being aligned or flush, it is understood that the components may not be perfectly aligned or flush. In some examples the components may not be parallel to each other and/or misaligned.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or operations, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or operations, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, and articles of manufacture have been disclosed that provide connectors for processing packages. The example connectors disclosed herein provide a design to allow for faster communication of data while allowing cables to be connected and/or disconnected from a processing package without removal of a heat sink used to mitigate heat produced by the processing package.

Examples and combinations of examples disclosed herein include the following: Example 1 includes a male connector comprising a plurality of wires, a socket pin, a paddle board connected to the socket pin, an overmolded cable housing the plurality of wires, the overmolded cable coupled to the paddle board, one of the plurality of wires coupled to the socket pin via the paddle board, and a molded region to encompass the plurality of wires within a flat portion, the overmolded cable housing and the molded region to increase a height of the wires from the paddle board from a first height to a second height.

Example 2 includes the male connector of example 1, further including a clip connected to the overmolded cable, the clip including a protrusion to engage with a slot of a female connector.

Example 3 includes the male connector of example 1, wherein the overmolded cable and the molded region have at least one of a sigmoid shape, a step shape, or an angled shape.

Example 4 includes the male connector of example 3, wherein the shape of the overmolded cable and the molded region is structured to avoid contact with impeding objects when the male connector is inserted into a female connector.

Example 5 includes the male connector of example 3, wherein the shape of the overmolded cable houses the plurality of wires in parallel.

Example 6 includes the male connector of example 1, further including a plate coupled to a first side of the paddle board, the plate to engage with a spring of a female connector.

Example 7 includes the male connector of example 6, further including a socket connector coupled to a second side of the paddle board, the socket connector housing the socket pin.

Example 8 includes the male connector of example 7, wherein the socket connector includes a mounting opening, the mounting opening to engage with a mounting pin of the female connector.

Example 9 includes an apparatus comprising a circuit board, a processing package including a landing pad, a loading mechanism coupled to the circuit board, the loading mechanism housing the processing package, and a female connector including a guide rail bracket coupled to the loading mechanism, a first spring connected to the guide rail bracket, the first spring to move from a first initial position to a first compressed position, the spring extending in parallel from the guide rail bracket in the first initial position, the spring disposed at an angle relative to the guide rail bracket in the first compressed position, and a second spring above the landing pad of the processing package, the second spring to move from a second initial position to a second compressed position, the spring closer to the landing pad in the second compressed position than the second initial position.

Example 10 includes the apparatus of example 9, further including a heat sink, and a carrier coupled to the loading mechanism and the heat sink, the female connector including an opening formed by a portion of the carrier and the guide rail bracket.

Example 11 includes the apparatus of example 9, wherein the female connector further includes a fastener coupled to the second spring.

Example 12 includes the apparatus of example 11, wherein the second spring is to move from the second initial position to the second compressed position in response to movement of the fastener.

Example 13 includes the apparatus of example 11, further including a heat sink including an opening, the fastener housed in the opening, the opening to provide access to the fastener without removal of the heat sink.

Example 14 includes the apparatus of example 9, wherein, when a male connector is inserted into the female connector, the second spring presses the male connector into contact with the landing pad of the processing package when the female connector is in the second compressed position.

Example 15 includes the apparatus of example 14, wherein, when the male connector is in contact with the landing pad of the processing package, the first spring is in the first compressed position.

Example 16 includes the apparatus of example 15, wherein in the first compressed position, the first spring applies a force on the male connector.

Example 17 includes the apparatus of example 16, wherein, when the second spring is adjusted from the second compressed position to the second initial position, the first spring moves the male connector away from the processing package.

Example 18 includes a female connector including an opening, a guide rail bracket, a first spring connected to the guide rail bracket, the first spring to move from a first initial position to a first compressed position, the spring extending in parallel from the guide rail bracket in the first initial position, the spring disposed at an angle relative to the guide rail bracket in the first compressed position, and a second spring located above a processing package, the second spring to move from a second initial position to a second compressed position, the spring closer to the landing pad in the second compressed position than the second initial position.

Example 19 includes the female connector of example 18, wherein, when a male connector is inserted into the female connector, the second spring presses the male connector into contact with the processing package when the second spring is in the second compressed position.

Example 20 includes the female connector of example 14, wherein, when the male connector is in contact with the landing pad of the processing package, the first spring is in the first compressed position and applies a force on the male connector.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A male connector comprising:
a plurality of wires;
a socket pin;
a paddle board connected to the socket pin;
an overmolded cable housing the plurality of wires, the overmolded cable coupled to the paddle board, one of the plurality of wires coupled to the socket pin via the paddle board; and
a molded region to encompass the plurality of wires within a flat portion, the overmolded cable housing and the molded region to increase a height of the wires from the paddle board from a first height to a second height.

2. The male connector of claim 1, further including a clip connected to the overmolded cable, the clip including a protrusion to engage with a slot of a female connector.

3. The male connector of claim 1, wherein the overmolded cable and the molded region have at least one of a sigmoid shape, a step shape, or an angled shape.

4. The male connector of claim 3, wherein the shape of the overmolded cable and the molded region is structured to avoid contact with impeding objects when the male connector is inserted into a female connector.

5. The male connector of claim 3, wherein the shape of the overmolded cable houses the plurality of wires in parallel.

6. The male connector of claim 1, further including a plate coupled to a first side of the paddle board, the plate to engage with a spring of a female connector.

7. The male connector of claim 6, further including a socket connector coupled to a second side of the paddle board, the socket connector housing the socket pin.

8. The male connector of claim 7, wherein the socket connector includes a mounting opening, the mounting opening to engage with a mounting pin of the female connector.

9. An apparatus comprising:
a circuit board;
a processing package including a landing pad;
a loading mechanism coupled to the circuit board, the loading mechanism housing the processing package; and
a female connector including:
a guide rail bracket coupled to the loading mechanism;
a first spring connected to the guide rail bracket, the first spring to move from a first initial position to a first compressed position, the spring extending in parallel from the guide rail bracket in the first initial position, the spring disposed at an angle relative to the guide rail bracket in the first compressed position; and
a second spring above the landing pad of the processing package, the second spring to move from a second initial position to a second compressed position, the spring closer to the landing pad in the second compressed position than the second initial position.

10. The apparatus of claim 9, further including:
a heat sink; and
a carrier coupled to the loading mechanism and the heat sink, the female connector including an opening formed by a portion of the carrier and the guide rail bracket.

11. The apparatus of claim 9, wherein the female connector further includes a fastener coupled to the second spring.

12. The apparatus of claim 11, wherein the second spring is to move from the second initial position to the second compressed position in response to movement of the fastener.

13. The apparatus of claim 11, further including a heat sink including an opening, the fastener housed in the opening, the opening to provide access to the fastener without removal of the heat sink.

14. The apparatus of claim 9, wherein, when a male connector is inserted into the female connector, the second spring presses the male connector into contact with the landing pad of the processing package when the female connector is in the second compressed position.

15. The apparatus of claim 14, wherein, when the male connector is in contact with the landing pad of the processing package, the first spring is in the first compressed position.

16. The apparatus of claim 15, wherein in the first compressed position, the first spring applies a force on the male connector.

17. The apparatus of claim 16, wherein, when the second spring is adjusted from the second compressed position to the second initial position, the first spring moves the male connector away from the processing package.

18. A female connector including:
an opening;
a guide rail bracket;
a first spring connected to the guide rail bracket, the first spring to move from a first initial position to a first compressed position, the spring extending in parallel from the guide rail bracket in the first initial position, the spring disposed at an angle relative to the guide rail bracket in the first compressed position; and
a second spring located above a processing package, the second spring to move from a second initial position to a second compressed position, the spring closer to the landing pad in the second compressed position than the second initial position.

19. The female connector of claim 18, wherein, when a male connector is inserted into the female connector, the second spring presses the male connector into contact with the processing package when the second spring is in the second compressed position.

20. The female connector of claim 14, wherein, when the male connector is in contact with the landing pad of the processing package, the first spring is in the first compressed position and applies a force on the male connector.
